(19) United States
(12) Patent Application Publication
(10) Pub. No.: US 2007/0119552 A1
(43) Pub. Date: May 31, 2007

(54) Window curtain rolling device

(76) Inventors: Wen-Ren Wang, Pingtung County (TW); Chih-Yung Wang, Pingtung County (TW)

Correspondence Address: BIRCH STEWART KOLASCH & BIRCH, PO BOX 747, FALLS CHURCH, VA, 22040-0747, US

(21) Appl. No.: 11/288,252

(22) Filed: Nov. 29, 2005

(51) Int. Cl. E06B 9/56

(52) U.S. Cl. 160/321

(57) ABSTRACT

The present invention discloses a window curtain rolling device that comprises a guide module, a fixed casing, a movable coupling module, a coupling module, and a rotary module, wherein a guide rod of the guide module having a fixed casing is coupled with the movable coupling module, and the movable coupling module includes a corresponding guide groove around the periphery of the movable coupling module for allowing a rolling bead covered by the coupling module to slide or latch along the guide groove or at other positions and directions, so that when a user operates a pulling up and close device coupled to the embedding member at another end of the fixed casing, the user can control the speed of rolling the window curtain effectively.

### FIELD OF THE INVENTION

The present invention relates to a rolling device, and more particularly to a rolling device that uses a movable coupling module and a guide module to connect and control a window curtain to be rolled smoothly from different directions at different speeds.

### BACKGROUND OF THE INVENTION

The present common curtain devices are used for shading sunlight or serving as a decoration, and these devices usually adopt a pulling string to roll the curtain up or down. However, such curtain is applicable for the Venetian curtain or the curtains that can be opened or closed sideway (from a left side or a right side), but it is not applicable for the one-piece curtains. The window curtain rolling device is comprised of a casing, a bushing, an external casing, a cover, and a rotary member. However, the aforementioned curtain rolling device still has the following problems:
1. The external casing cannot be changed easily. The external casing includes a groove around the periphery of the external casing, such that when the external casing is sheathed into the bushing, a protruded rod at the internal side of the bottom is inserted into a center hole of an axle rod at the center of the bushing, such that a blocking member protruded from an end of a spring at the axle rod is latched into the groove. If the external casing is rotated clockwise or counterclockwise, the spring will be propped outward to constitute an idle state, and the window curtain is pulled open or the spring is fixed to drive the bushing to rotate, so as to slow down the speed of rolling the window curtain. However, the curtain device can only install the external casing at the original fixing direction, and its using range is limited.
2. The rolling direction for opening or closing the window curtain cannot be changed according to the user's rolling action, and the rolling device can be installed only at a direction for rolling up and down the window curtain. General users cannot change the direction according to their using habits. Therefore, the change of the rolling direction in a clockwise direction or a counterclockwise direction is not easily. It wastes a great deal of time for replacing the component modules, and thus affecting the overall installation operation of the window curtain.

### SUMMARY OF THE INVENTION

In view of the foregoing shortcomings of the prior art, the present invention overcomes the shortcoming by providing a window curtain rolling device, so that when a user changes the left and right directions of a movable coupling module of the window curtain rolling device, the user can control the rolling direction and slow down the speed of rolling the window curtain to achieve a smooth rolling effect.

With the structural design of the foregoing window curtain rolling device, the present invention can achieve the following effects. Firstly, the design of the movable coupling module allows users to make changes to a guide rod at an end of the guide module, so that the user can change the direction of rolling a window curtain according to the user's using habit. Secondly, the movable coupling module includes several corresponding guide grooves disposed around the periphery of the movable coupling module for guiding the rolling beads of an externally covered coupling module to slide or latch along the guide groove and at other positions or directions, such that the window curtain can be rolled at different directions with a slower speed, so as to roll the window curtain smoothly.

### BRIEF DESCRIPTION OF THE DRAWINGS

FIG. 1 is an exploded view of the present invention;

FIG. 2 is a perspective view of the present invention;

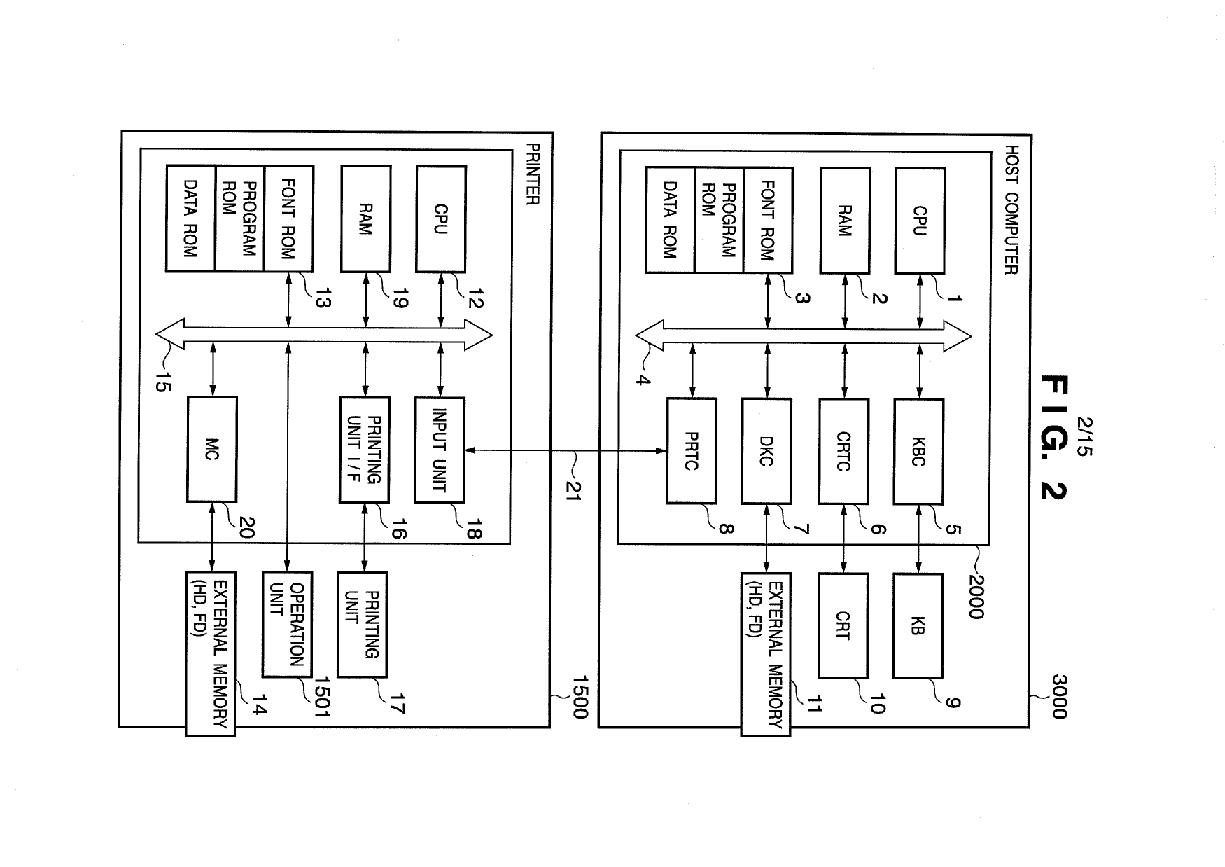

FIG. 3 is a cross-sectional view of an assembly of the present invention;

FIG. 4 is a schematic view of a using state (rolling the curtain) of the present invention;

FIG. 5 is a schematic view of a using state (pulling up the curtain) of the present invention;

FIG. 6 is a schematic view of a layout of the present invention;

FIG. 7 is a schematic view of another using state (rolling the curtain) of the present invention; and

FIG. 8 is a schematic view of another using state (pulling up the curtain) of the present invention.

### DETAILED DESCRIPTION OF THE PREFERRED EMBODIMENTS

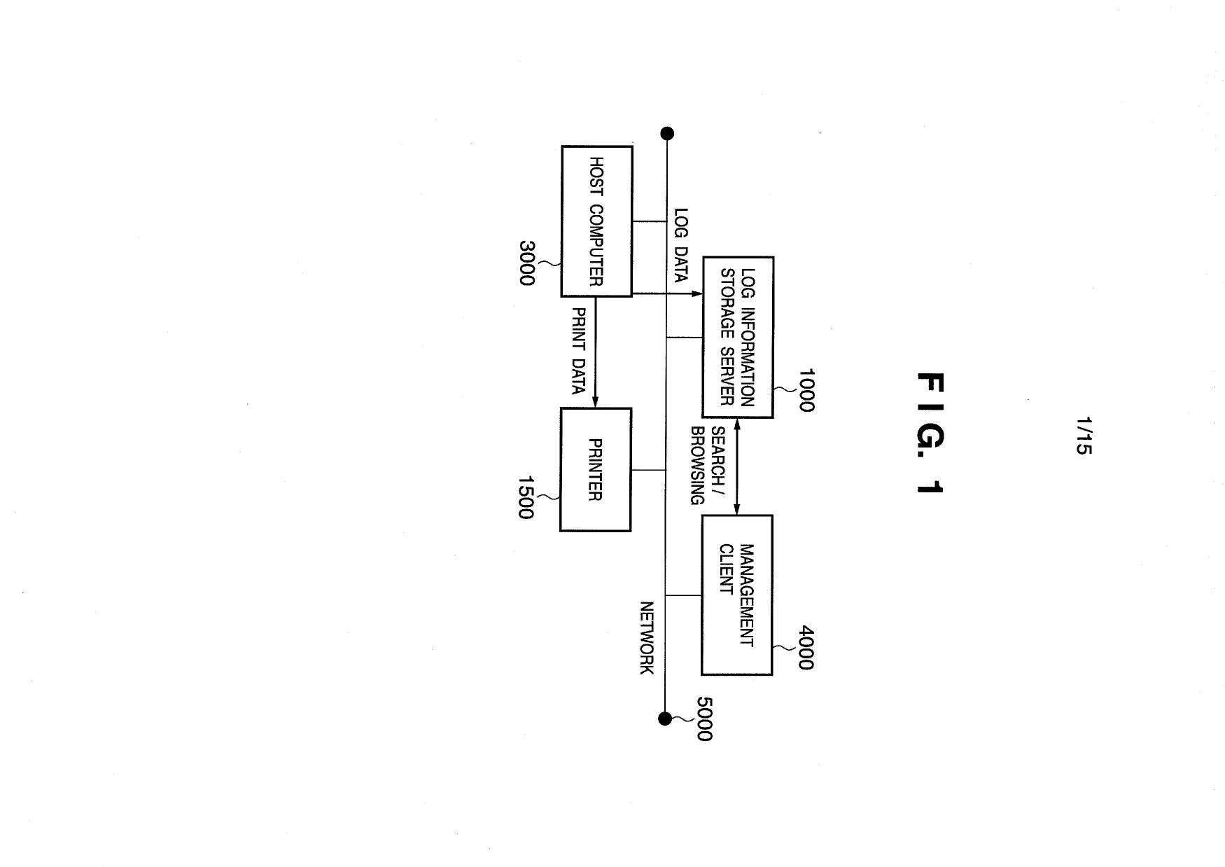

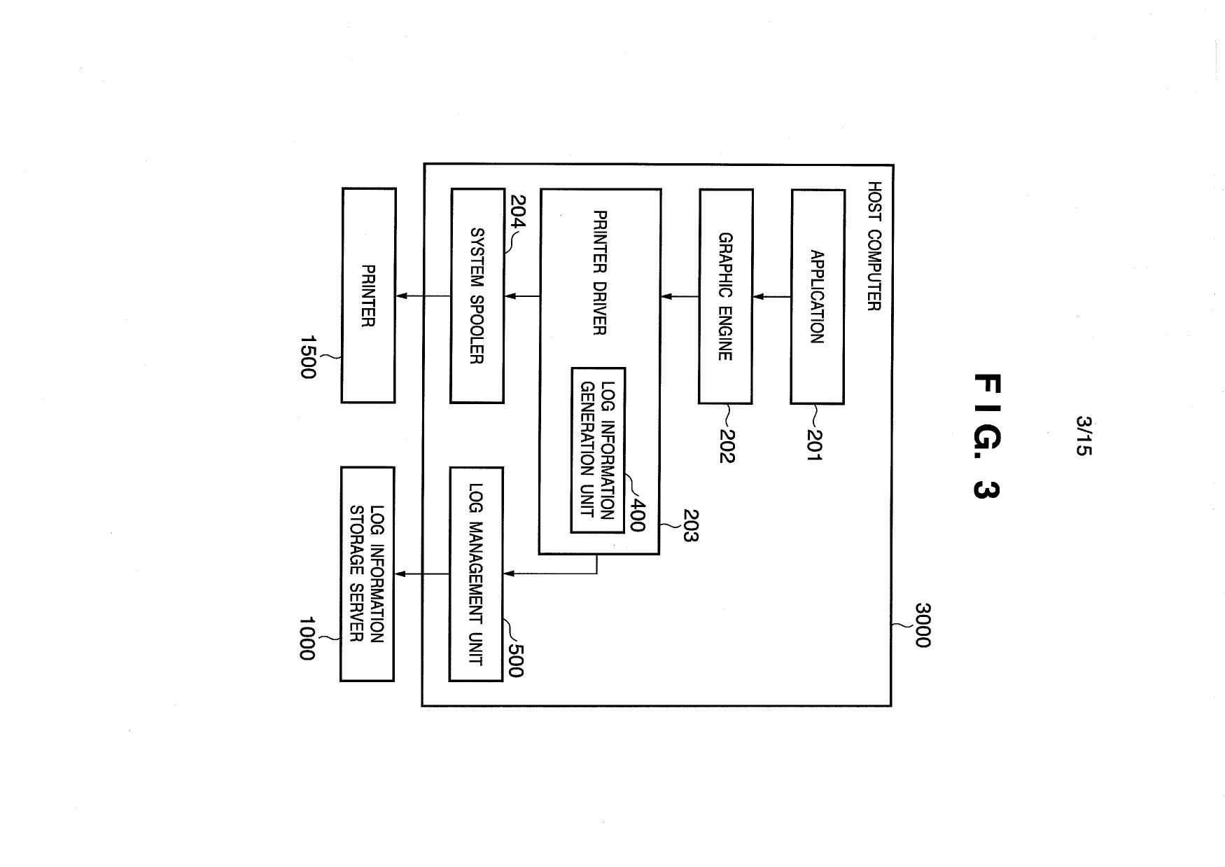

Referring to FIGS. 1 and 3, the window curtain rolling device of the present invention comprises a guide module 10, a fixed casing 20, a movable coupling module 30, a coupling member 40, and a rotary module 50.

The guide module 10 includes a square guide rod 11 disposed at one end, and the guide rod 11 includes a protruded rod 110 disposed proximate to an end of the guide rod 11 and coupled to a cushion member 111, and a protruded circular member 12 disposed at another end of the guide rod 11. The protruded circular member 12 includes a top pressing end 120 coupled to a cushion member 121 and disposed proximate to the guide rod 11, and a sheathing hole 112, 122 is formed separately on both distal surfaces.

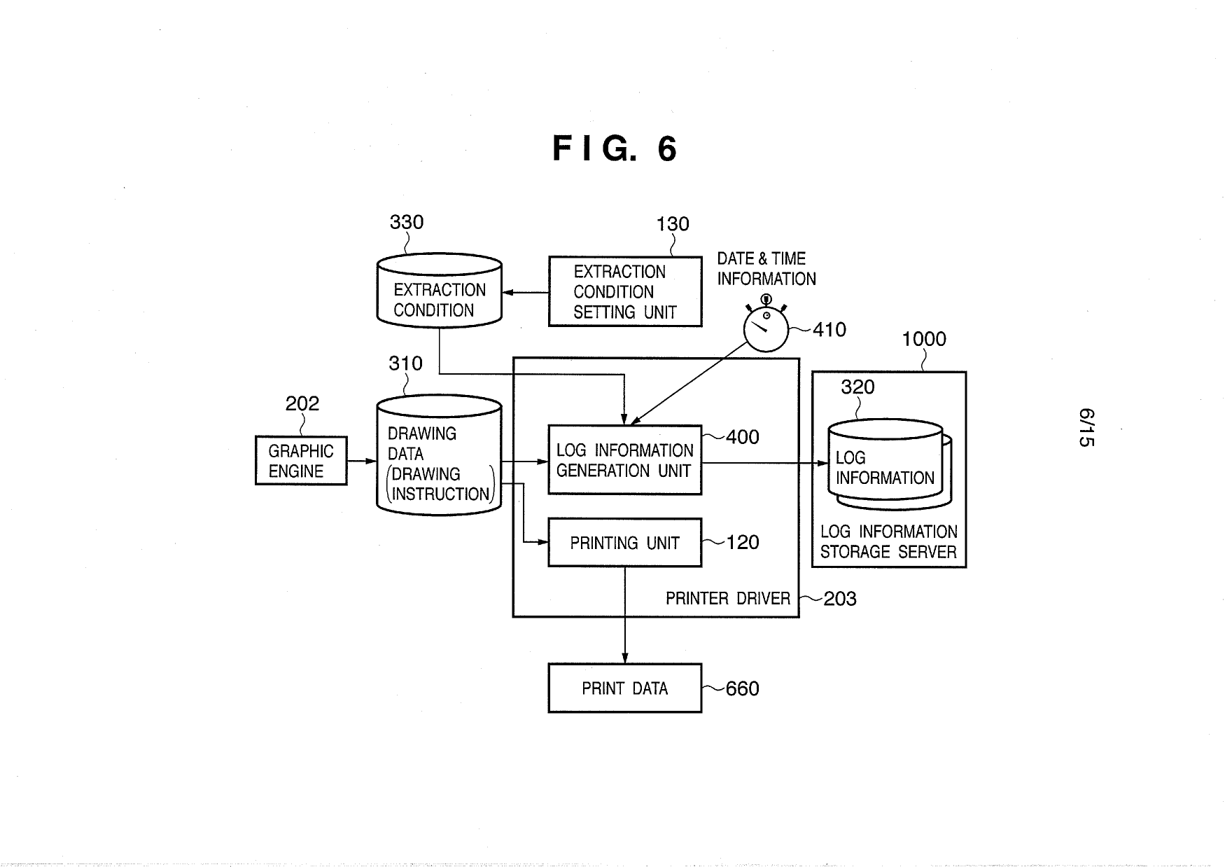

The fixed casing 20 is sheathed onto the guide module 10, and the fixed casing 20 includes an external casing 21 and a cover 22, and an end of the external casing 21 has a through hole 210 for receiving a square guide rod 11, and the through hole 210 includes a containing space 211 therein for inserting the protruded circular member 12, such that a lubricating liquid 2110 can be applied to a gap between the protruded circular member 12 and the containing space 211, and the external casing 21 includes a corresponding notch 212 disposed at the upper edge of another end, and a depressed surface 213 disposed at the internal edge of its end. Further, the cover 22 includes a coupling wall 220 disposed at the depressed surface 213, and the cover 22 includes a latch 221 disposed at the periphery and corresponding to two notches 212 disposed at another end of the external casing 21. A protruded rod 222 is extended outward from the middle of a side of the coupling wall 220, and the protruded rod 222 is sheathed into the sheathing hole 122 on the distal surface of a protruded circular member 12 at the other end of the guide module 10. A pulling up and close device 60 (as shown in FIG. 6) is installed at another end of the cover 22 and coupled to an embedding member 223.

The movable coupling module 30 is installed onto a guide rod 11 at an end of the guide module 10 and includes a square hole 31 disposed at its middle and pivotally coupled to a square guide rod 11, and a protruded connecting member 32, 33 is disposed separately on both ends, and a guide groove 34 is disposed around its periphery and interconnected to corresponding left and right grooves 340, 341, and a latched end 3400, 3410 is disposed separately at an end of the left and right grooves 340, 341, such that the rolling bead 35 follows the path of the left and right grooves 340, 341 of the guide groove 34 and is latched at the latched end 3400, 3410.

The shape of the coupling module 40 can be changed according to the aluminum extruded body, and the coupling module 40 is sheathed onto the movable coupling module 30 and includes a containing space 41 therein. The containing space 41 includes a groove 410 having an arc cross section and disposed around its periphery for allowing the rolling bead 35 to slide along the path of the arc groove 410, and the coupling module 40 includes a through hole 42 at a distal surface, and the through hole 42 is provided for receiving an end of the protruded connecting member 32 of the movable coupling module 30. Further, the coupling module 40 includes a fixed member 43 fixed onto a distal surface, and the fixed member 43 includes a penetrating hole 430 at the middle for inserting a locking device 44, and the fixed member 43 includes a square concave hole 431 disposed proximate to a distal surface of the coupling module 40 for embedding a guide rod 11 at an end of the guide module 10, and a square member 432 is disposed at the other end.

The rotary module 50 includes a square hole 51 disposed at the middle of a side of the rotary module 50 and embedded with the corresponding square member 432 at another distal surface of the fixed member 43.

Referring to FIG. 3 for the assembly of the present invention, the guide rod 11 at an end of the guide module 10 is passed into the containing space 211 of the external casing 21 of the fixed casing 20 and out from an end of the through hole 210. The cushion member 111 of the protruded rod 110 of the guide module 10 and the cushion member 121 of the top pressing end 120 at the other end of the protruded circular member 12 block the containing space 211 and the through hole 210 respectively. A protruded rod 222 at the middle of the coupling wall 220 of a cover 22 is sheathed into the sheathing hole 122 on a distal surface of the protruded circular member 12 at the other end of the guide module 10, and the latch 221 protruded from the periphery of the cover 22 is embedded into two notches 212 at the other end of the external casing 21 for preventing any leak of the lubricating liquid 2110 applied to the gap between the protruded circular member 12 and the containing space 211 of the external casing 21, and the embedding member 223 at the other end of the cover 22 is coupled with a pulling up and close device 60 (as shown in FIG. 6). The guide rod 11 at an end of the guide module 10 is pivotally coupled to a movable coupling module 30, and the movable coupling module 30 includes a rolling bead 35 disposed in the guide groove 34 that is interconnected to the corresponding left and right grooves 340, 341. The coupling module 40 having an arc groove 410 at a position of the rolling bead 35 in the containing space 41 is sheathed onto the movable coupling module 30, and an end of the guide rod 11 is embedded into the square concave hole 431 of the fixed member 43, and a locking device 44 is inserted into the penetrating hole 430 at the middle of the fixed member 43 and fixed into the sheathing hole 112 at the distal surface of the guide rod 11.

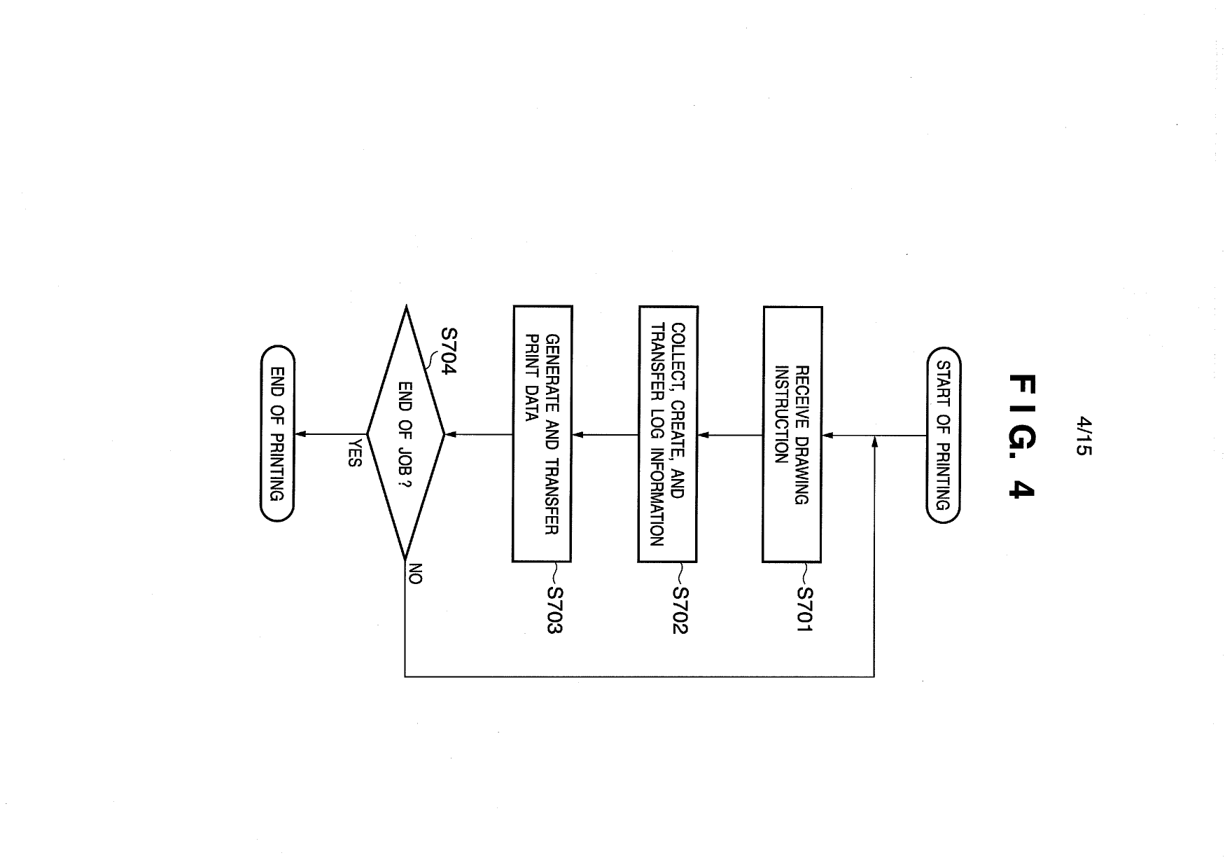

Referring to FIG. 4 for the operation of the present invention, the rolling device is installed to any curtain device (not shown in the figure) and it is necessary to roll up a window curtain (not shown in the figure) in a clockwise direction. The rolling bead 35 at the guide groove 34 of the movable coupling module 30 moves along the path of the left and right grooves 340, 341 and latches at the latched end 3400, 3410, and drives the guide module 10 having a movable coupling module 30 and coupled to the guide rod 11 to rotate. When the guide rod 11 is rotated clockwise, the guide rod 11 is obstructed by the lubricating liquid 2110 outside the protruded circular member 12 to constitute a reaction so to slow down the speed of rolling the window curtain.

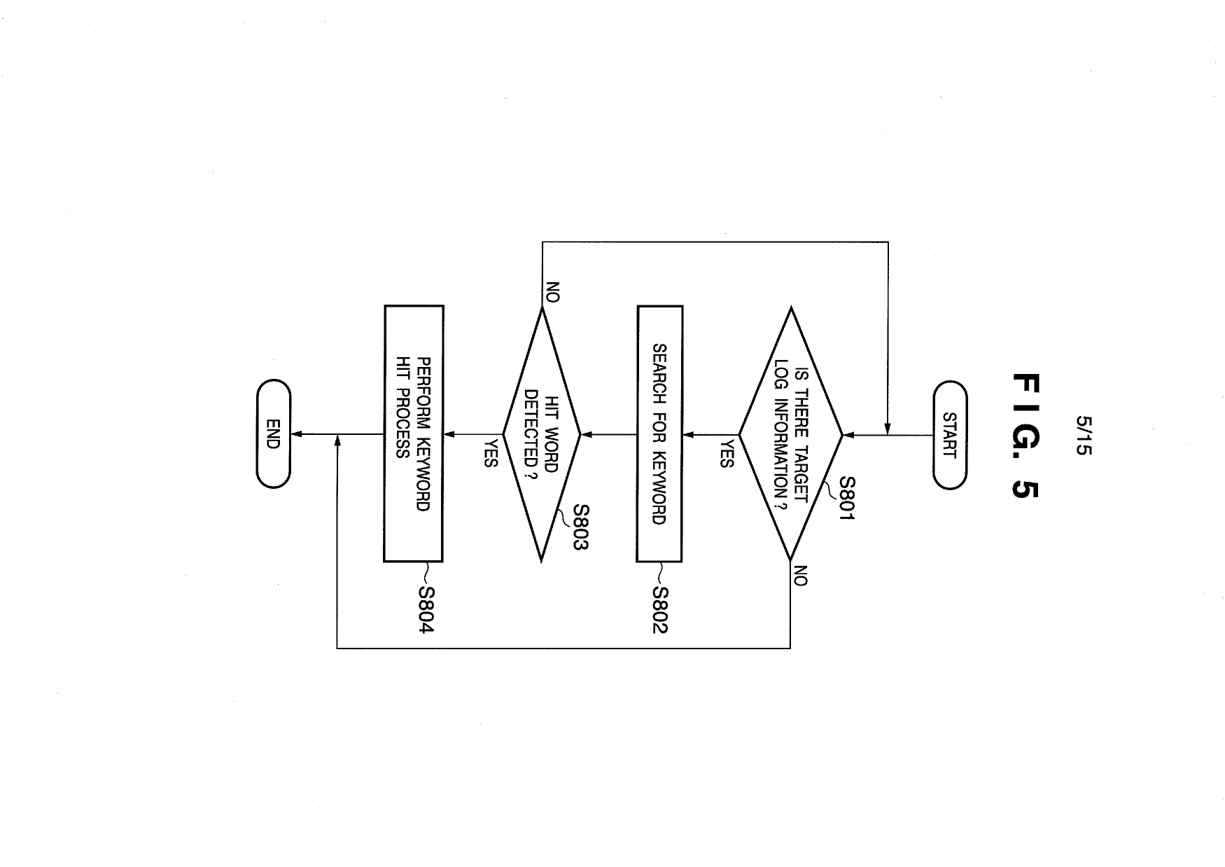

Referring to FIG. 5, if it is necessary to open the window curtain (not shown in the figure) by rotating the window curtain rolling device in a counterclockwise direction, then the rolling bead 35 on the guide groove 34 of the movable coupling module 30 moves along the path of the left and right grooves 340, 341 and the rolling bead 35 is in an idle state since the latched end 3400, 3410 is not latched, so that the guide module 10 having a guide rod 11 at one end and coupled to the movable coupling module 30 is not rotated and the window curtain can be pulled open successfully.

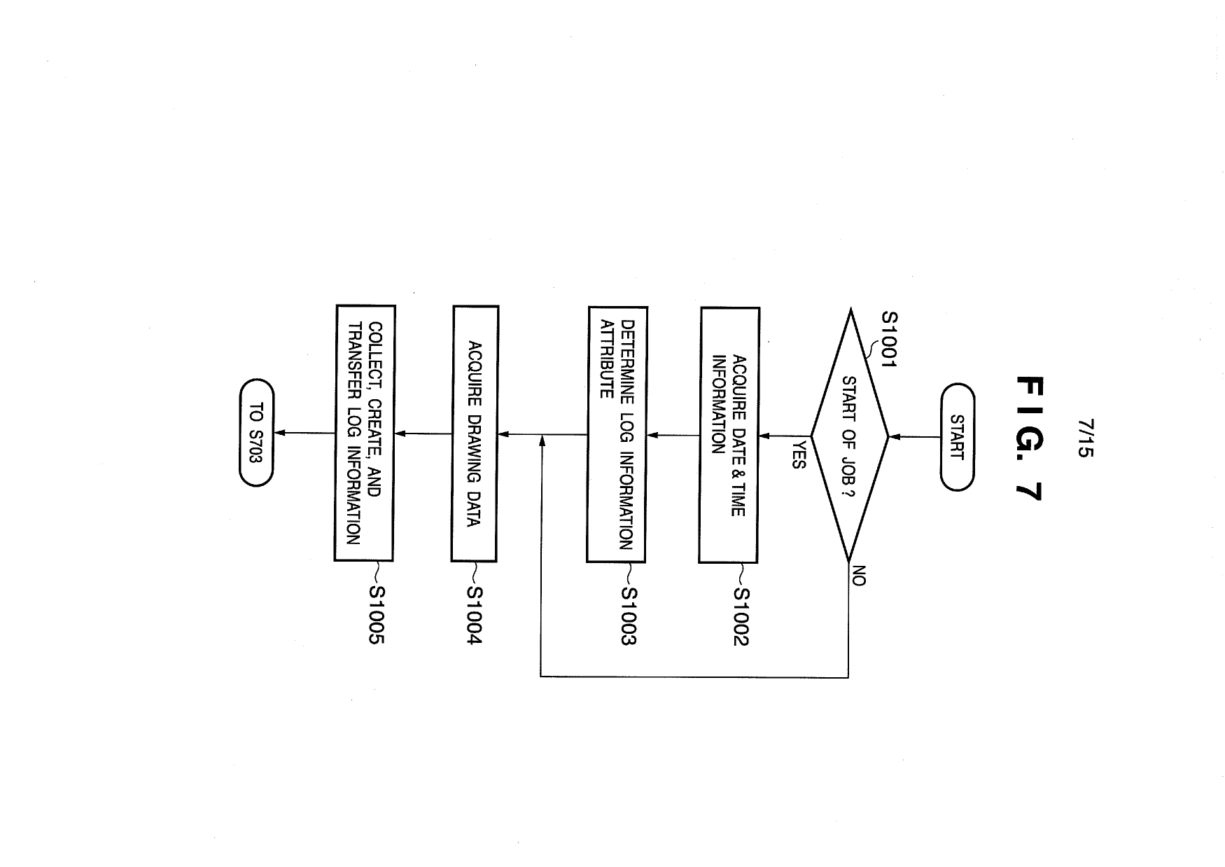

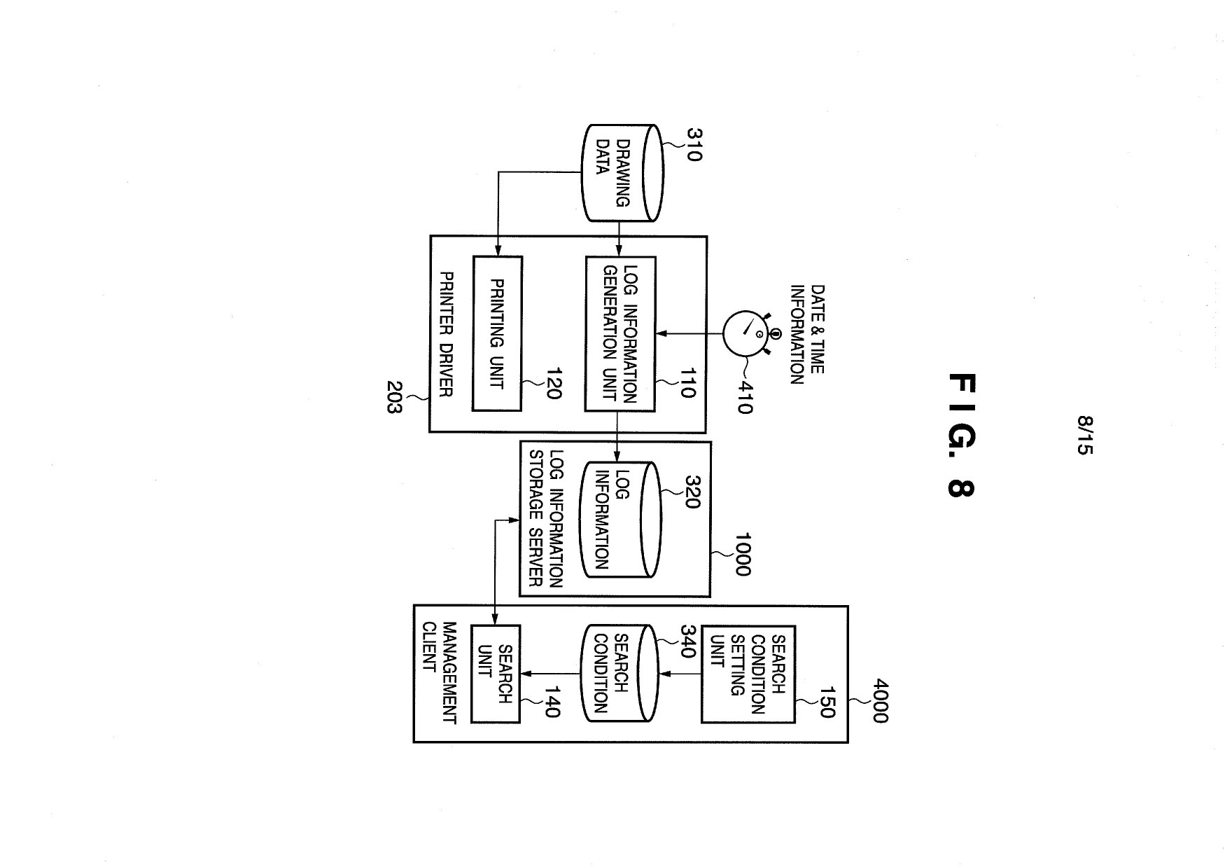

Referring to FIG. 7, if the window curtain of the invention is rolled up or pulled up in a different direction, then the direction of the movable coupling module 30 as shown in FIGS. 4 and 5 is changed from the left side to the right side to roll up the window curtain in a counterclockwise direction, so that the rolling bead 35 on the guide groove 34 of the movable coupling module 30 is changed to the bottom according to the latched end 3400, 3410 of the left and right grooves 340, 341, and the rolling bead 35 moves along the path and forms a latch state at the latched end 3400, 3410 and drives the guide module 10 having a guide rod 11 at one end and coupled to the movable coupling module 30. When the guide rod 11 is rotated counterclockwise, the guide rod 11 is obstructed by the lubricating liquid 2110 outside the protruded circular member 12 and constitutes a reaction to slow down the speed of rolling the window curtain. Referring to FIG. 8, if the window curtain is pulled up by rotating the window curtain rolling device clockwise, then the rolling bead 35 on the guide groove 34 of the movable coupling module 30 moves along the interconnected left and right grooves 340, 341 and it is in an idle state since the latched end 3400, 3410 is not latched, so that the guide module 10 having a guide rod 11 at one end and coupled to the movable coupling module 30 is not rotated, so as to pull up the window curtain successfully. With the present invention, users can use the foregoing operating procedure to remove the movable coupling module and install it from another direction to meet the requirements of installing the window curtain rolling device for pulling up or rolling up the window curtain.

The invention being thus described, it will be obvious that the same way be varied in many ways. Such Variations are not to be regarded as a departure from the spirit and scope of the invention, and all such modifications as would be obvious to one skilled in the art are intended to be included within the scope of the following claims.

What is claimed is:

1. A window curtain rolling device, comprising:
a guide module, having a guide rod at one end and a protruded circular member at the other end, and said protruded circular member having a top pressing end with a cushion member and disposed proximate to said guide rod, and a sheathing hole separately disposed on both distal surfaces of said top pressing end;
a fixed casing, being sheathed onto said guide module and including an external casing and a cover, and an end of said external casing having a through hole, and said through hole defining a containing space disposed on one side therein, and the upper edge of another end having a corresponding notch and a depressed surface disposed at the internal edge therein, and said cover including a coupling wall, a protruded rod extended from the middle of a side of said coupling wall, and an embedding member disposed at another end, and said cover including a corresponding latch protruded from the periphery of said cover;
a movable coupling module, disposed on said guide rod at an end of said guide module and having a square hole disposed at the middle, a protruded connecting member separately disposed on both ends, and a guide groove disposed around the periphery and interconnected to said left and right grooves; and
a coupling module, sheathed onto said movable coupling module and having a containing space therein, an arc groove disposed at the periphery of said coupling module, and a through hole disposed at its distal surface.

2. The window curtain rolling device of claim 1, wherein said guide rod is square in shape, and said guide rod includes a protruded rod disposed proximate to an end of said guide rod and coupled to a cushion member.

3. The window curtain rolling device of claim 1, wherein said left and right grooves have a latched end separately disposed on one end of said left and right grooves.

4. The window curtain rolling device of claim 1, wherein said coupling module includes a fixed member secured out of a distal surface of said coupling module.

5. The window curtain rolling device of claim 4, wherein said fixed member includes a penetrating hole disposed at the middle of said fixed member, and a square concave hole disposed at a distal surface, and a square member disposed at another distal surface.

6. The window curtain rolling device of claim 1, further comprising a lubricating liquid applied to a gap between said protruded circular member and said external casing containing space.
